(19) United States
(12) Patent Application Publication
(10) Pub. No.: US 2009/0013400 A1
(43) Pub. Date: Jan. 8, 2009

(54) Method of filtering undesirable streams coming from a terminal presumed to be malicious

(75) Inventors: Amdjed Mokhtari, Caen (FR); Sylvie Laniepce, Caen (FR)

Correspondence Address: COHEN, PONTANI, LIEBERMAN & PAVANE LLP, 551 FIFTH AVENUE, SUITE 1210, NEW YORK, NY, 10176, US

(73) Assignee: France Telecom, Paris (FR)

(21) Appl. No.: 12/150,433

(22) Filed: Apr. 28, 2008

(30) Foreign Application Priority Data
Apr. 27, 2007 (FR) 07/54774

(51) Int. Cl. G06F 21/00

(52) U.S. Cl. 726/13

(57) ABSTRACT

A method of filtering undesirable streams coming from a terminal (20) presumed to be malicious belonging to an overlay network superposed on an underlying communications network (1, 2), comprising the following steps executed by an undesirable stream control entity (100, 200): a step of receiving a request to filter a stream coming from a terminal (20) presumed to be malicious sent by a requesting terminal (10) belonging to the overlay network; a step of determining a node (30-33) of said communications network (1, 2) able to filter said stream; and a step of sending the determined node a command to filter said stream.

The invention relates to a technique of filtering undesirable streams coming from a terminal presumed to be malicious belonging an overlay network superposed on an underlying communications network.

In a communications network, a number of terminals are interconnected and can form an overlay network, for example of the peer-to-peer type, referred to below as P2P networks. These terminals, called peers, are not differentiated and have equivalent capacities and responsibilities in the network, in contrast to a client-server architecture. The communications network underlies the P2P network. The P2P network can overlie a number of communications networks.

In a P2P network, peers communicate and share resources, for example computation capacities or information elements.

This type of network relies on mechanisms of mutual confidence between the various peers. P2P networks are particularly vulnerable to attacks from the underlying network, such as repetitive sending of data to a peer. Further vulnerability is caused by their security failings. The opening by one peer to other peers of functions such as shared storage capacity, processing capacity, and bandwidth, makes a P2P network an easy target for malicious peers to propagate hazardous content, such as viruses, worms, prohibited data, or unsolicited messages (spam), or to make excessive use of peers' resources. To protect peers, reputation management techniques have been proposed for this type of network.

The peers of a P2P network detect selfish or malicious peers by pooling assessments formulated during previous experiences. Each peer that has effected a transaction with another peer in the P2P network can then assess that other peer and share its assessment with other peers. Thus each peer administers a confidence level database. It can therefore avoid interacting with peers with a poor assessment. However, it cannot limit attacks coming from peers presumed to be malicious nor can it limit interaction with such peers.

There is therefore a need for a technique enabling a peer to protect itself from other peers in a cooperative network.

The invention addresses this requirement by proposing a method of filtering undesirable streams coming from a terminal presumed to be malicious belonging to an overlay network superposed on an underlying communications network, the method comprising the following steps executed by an undesirable stream control entity:

a step of receiving a request to filter a stream coming from a terminal presumed to be malicious sent by a requesting terminal belonging to the overlay network;

a step of determining a node of said communications network able to filter said stream; and

a step of sending the determined node a command to filter said stream.

After identifying that a terminal presumed to be malicious is sending it an undesirable stream, a requesting terminal can request a control entity to filter one or more streams coming from the terminal presumed to be malicious. The control entity, which is attached to an underlying network, determines a node of the network able to filter the undesirable stream(s) from information relating to the terminal presumed to be malicious and to the requesting terminal and as a function of the topology of the underlying network. If the terminal presumed to be malicious is located in the same underlying network, it may be the node to which it is attached, i.e. the node that serves its network address, for example the node that serves the prefix of its IP address. If the terminal presumed to be malicious is located in another underlying communications network, it may be a node of the underlying network to which the requesting terminal is attached. The control entity then sends to the determined node information relating to the stream that is necessary for filtering the stream. For example, this information comprises the respective TCP port numbers and the addresses in the underlying communications network, for example the IP addresses, of the requesting terminal and the terminal presumed to be malicious. The determined node then filters the undesirable stream on the basis of this information. It is not necessary for it to effect an in-depth analysis of the data sent in the flows in order to filter the streams. It is also not sensitive to activation of a data protection function such as encryption. The processing resources of the node are therefore protected, in contrast to techniques of the deep packet inspection (DPI) type that analyze the traffic at the application level, which requires a continuous analysis of a very large quantity of data, both data from the data packet header and application data.

Prior to the step of receiving a filtering request sent by a requesting terminal, the method further comprises a step of registering the requesting terminal with the control entity and, if the requesting terminal is no longer registered with said entity, a step of sending the determined node a command to cancel filtering of said stream.

Thus the requesting terminal is registered with the undesirable stream control entity and obtains a session identifier. The control entity can then store all filtering requests sent by the requesting terminal, in association with the session identifier. At the time of deregistration, the control entity requests the determined node to stop filtering. Thus the communications network does not remain responsible for filtering commands that are no longer of interest to the requesting terminal.

Moreover, if the terminal presumed to be malicious is registered with another undesirable stream control entity, the method further comprises a step of the control entity notifying the presumption of maliciousness of the terminal presumed to be malicious to said other control entity.

If the terminal presumed to be malicious is itself registered with the same control entity, or with another control entity, it may have communicated its own session identifier to the requesting terminal. The control entity then notifies the presumption of maliciousness to the other control entity, the one managing the session with the terminal presumed to be malicious. The latter control entity stores the received notification, in association with the session identifier of the terminal presumed to be malicious. The other control entity can then in turn notify the terminal presumed to be malicious so that it can seek a cause of that presumption. For example, the network address, for example the IP address, of the terminal presumed to be malicious may have been stolen by another terminal. Thus the user of the terminal presumed to be malicious can respond to the perception of its reputation by other terminals.

Furthermore, if said other control entity receives a plurality of “presumed malicious” notifications in relation to a terminal presumed to be malicious, the method comprises a step of determining a node able to filter the streams sent by the terminal presumed to be malicious and a step of sending said determined node a command to filter all streams sent by the terminal presumed to be malicious.

If the control entity of the terminal presumed to be malicious receives a plurality of notifications sent by one or more control entities, it determines a node able to filter all the streams sent by the terminal. This avoids routing undesirable streams in the underlying communications networks and consequently avoids loading them unnecessarily. This also protects terminals registered with a control entity, as well as the other terminals.

The invention also relates to an entity for controlling undesirable streams coming from a terminal presumed to be malicious belonging to an overlay network superposed on an underlying communications network, comprising:

means for receiving a request to filter a stream coming from a terminal presumed to be malicious sent by a requesting terminal belonging to the overlay network;

means for determining a node of said communications network able to filter said stream; and

means for sending the determined node a command to filter said stream.

The invention further relates to a terminal belonging to an overlay network superposed on an underlying communications network, comprising:

means for determining a terminal presumed to be malicious belonging to the overlay network;

means for sending a filtering request to a control entity, adapted to send a request to filter a stream coming from the determined terminal presumed to be malicious.

The invention further relates to a system for control undesirable streams coming from a terminal presumed to be malicious belonging to an overlay network superposed on an underlying communications network, comprising a control entity and a requesting terminal as described above.

The invention further relates to:

a program for an entity for controlling undesirable streams coming from a terminal presumed to be malicious, comprising program code instructions adapted to command execution of the steps of the method when said program is executed by said entity.

a storage medium readable by a device in which the program is stored.

The invention can be better understood in the light of the following description of one particular embodiment of the method of the invention, which is given with reference to the appended drawings, in which:

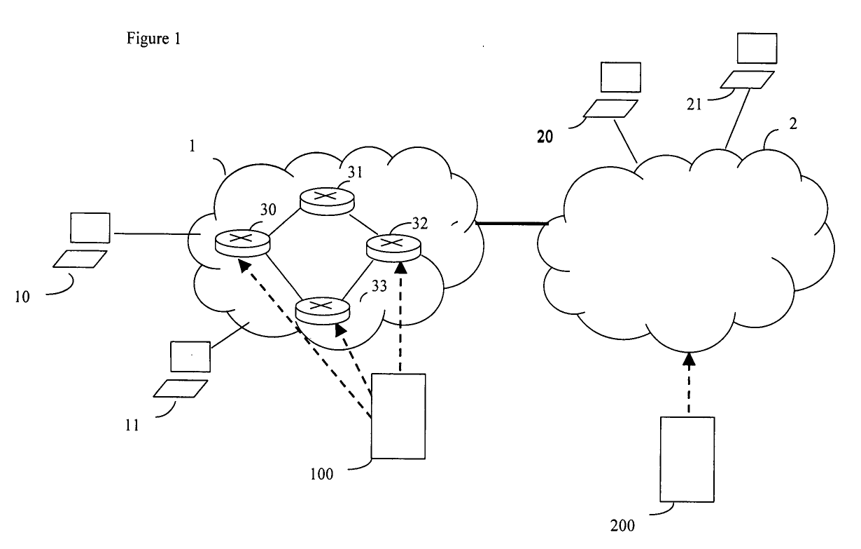

FIG. 1 represents an overlay network superposed on an underlying communications network;

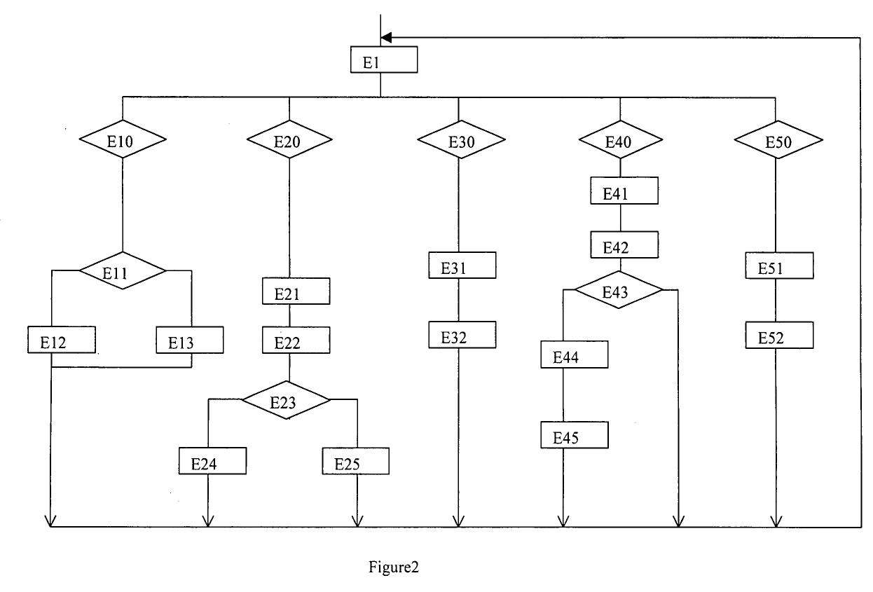

FIG. 2 represents the steps of one particular embodiment of the method of the invention as implemented by an undesirable stream control entity;

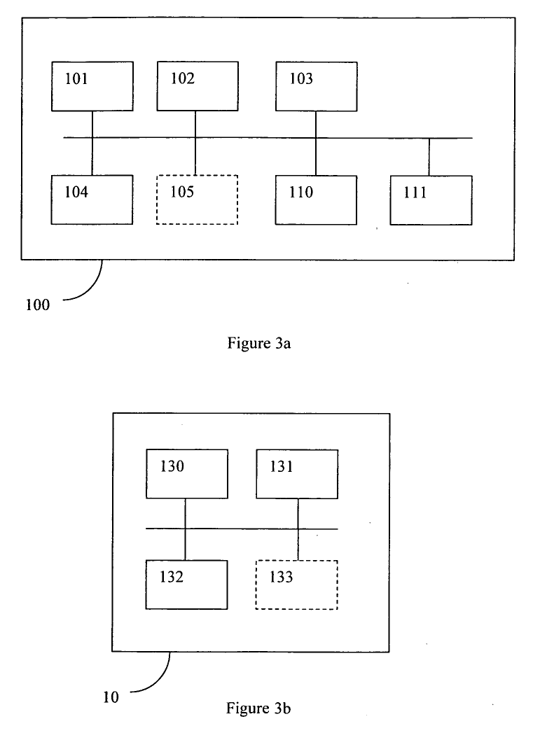

FIG. 3a is a functional block diagram of an undesirable stream control entity for implementing the method of the invention;

FIG. 3b is a functional block diagram of a requesting terminal for implementing the method of the invention.

FIG. 1 shows a network of terminals 10, 11, 20, and 21 superposed on two underlying communications networks 1, 2. The terminals 10, 11, 20, and 21 are interconnected and can form an overlay network, for example of the peer-to-peer type, referred to below as a P2P network. A P2P session between a first terminal and a second terminal is identified by respective addresses in the respective communications networks and by one TCP port number per terminal. The communications network 1 comprises interconnected routers 30, 31, 32, 33 able to route data packets in the network. For simplicity, FIG. 1 does not shown any routers in the communications network 2. This kind of network also comprises routers, of course. An undesirable stream control entity 100, respectively 200, is connected to the communications network 1, respectively the communications network 2. The control entities 100, 200 contain information representing the topology of their respective communications network. These control entities 100, 200 are also able to control routers 30-33 of the respective communications network 1, 2 to which they belong.

A stream is characterized by a number of characteristics common to a number of packets. These characteristics, or identification elements, can be present in different layers of the Open Systems Interconnection (OSI) model. They can correspond to the contents of the source and/or destination address fields (layer 3) or another field in the packet header, in particular the type of protocol (layer 3) and the port numbers for TCP or UDP segments (layer 4). Below, references to streams sent to a first terminal and coming from a second terminal refer to all primary streams for which the source address is equal to the address of the second terminal and the destination address is equal to the address of the first terminal. A primary stream also identifies the source and destination TCP ports.

The process of filtering undesirable streams coming from a terminal presumed to be malicious is described next with reference to FIG. 2.

In a first step E1 of waiting to receive a message, the undesirable stream control entity 100 waits to receive a message from a terminal or another control entity.

The user of the terminal 10 wishes to be registered with the malicious stream control service. To this end, the terminal sends the undesirable stream control entity 100 a registration message comprising an identification of the terminal, for example its address in the communications network 1, and information necessary for the entity to check the right of the terminal user to access the service.

In a step E10, the control entity 100 checks that the received message is a registration message. In a step E11 it checks if the user of the terminal is entitled to the service. If not, in a step E13, the registration request is rejected by sending a rejection message to the terminal 10 and the process loops to the step E1 of waiting to receive a message. If the user of the terminal 10 is entitled to the service, the control entity 100 assigns a session identifier Id_session1 and in a step E12 sends an acceptance message to the terminal 10. The control entity 100 also creates a record containing the address of the terminal 10 in the communications network and the session identifier Id_session1. The process then loops to the step E1 of waiting to receive a message.

The terminal 20 can be registered with the undesirable stream control entity 200 and obtain a session identifier Id_session2 in the same way.

In this example the requesting terminal is the terminal 10.

The terminal 10 sets up a P2P session with the terminal 20.

If the terminal 20 is registered with the control entity, on initialization of the P2P session the terminals 10 and 20 exchange their respective session identifiers. The terminal 10 then sends an enquiry message to the control entity 100 comprising the address of the terminal 20 and the session identifier Id_session2.

In a step E30, the control entity 100 checks that the message received is an enquiry message. Then, in a step E31, it determines the control entity to be contacted, i.e. the control entity 200 in this example, and sends it an enquiry for checking the authenticity of the information supplied by the terminal 20. By way of non-limiting example, the control entity that allocated that identifier can be deduced from the structure selected for the session identifier. If the terminal 20 is registered with the entity 200, the latter entity sends the entity 100 an acknowledgement message. Then, in a step E32, the entity 100 sends the requesting terminal 10 an acknowledgement message. The process loops to the step E1 of waiting to receive a message.

The terminal 10 then detects that the terminal 20 is exhibiting malicious behavior, for example misusing the resources of the terminal 10.

The terminal 10 can manage a confidence level database that stores confidence levels associated with respective peers of the P2P network. It is therefore able to evaluate a confidence level associated with a terminal, store confidence levels in its confidence level database, and share its own confidence levels with other terminals of the P2P network. Under such circumstances, it can update its own confidence level database by storing an unfavorable confidence level associated with the terminal 20.

The terminal 21 also contacts the terminal 10, but the user of the terminal 10 may not wish to establish contact with the terminal 21, for example because of an unfavorable confidence level stored in its confidence level database. That confidence level can be unfavorable because of previous negative experiences of its own or of other peers known as trusted peers.

Below, the terminals 20 and 21 are referred to as terminals presumed to be malicious.

The terminal 10 then sends the control entity 100 a request to filter at least one stream coming from the terminals 20 and/or 21 presumed to be malicious. This can be a single request concerning both terminals or two separate requests. Individual requests each concerning one terminal are considered. Requests can also concern all streams coming from the terminal presumed to be malicious and going to the requesting terminal or the stream associated with the P2P session, if it has been set up, as identified by the respective TCP ports and addresses of the requesting terminal and the terminal presumed to be malicious. The filtering request comprises the address in the communications network 2 of the terminal 20 or 21 presumed to be malicious. If a P2P session is set up, the filtering request further comprises the respective port numbers of the requesting terminal and the terminal presumed to be malicious. Moreover, in the present example, the terminal 20 is registered with a control entity 200 and the requesting terminal 10 has obtained during an identifier exchange step the session identifier Id_session2 associated with the terminal 20 presumed to be malicious; the filtering request then also contains the session identifier Id_session2 obtained in this way. Note that addresses in the communications network and aliases used in the P2P network do not constitute permanent data. Thus a terminal presumed to be malicious cannot be identified permanently by its address in the communications network or by its alias. Moreover, the confidence levels are specific to each terminal and vary in accordance with criteria that are also specific to the terminal.

It should also be noted that if the terminal belongs to a local area network and is connected to the communications network via a network address translation (NAT) unit, the association of the address in the network, corresponding to that of the NAT unit, and the TCP port number identifies the terminal uniquely. Thus undesirable stream filtering remains applicable even in the presence of NAT units.

In a step E20, the control entity 100 checks that the message received is a request sent by a requesting terminal 10 to filter one or more streams coming from the terminal 20, 21 presumed to be malicious.

In a step E21, using information received in the filtering request, in particular the address in the communications network 2 of the terminal 20, 21 presumed to be malicious, the control entity 100 determines a router 30-33 able to filter the stream(s). In the present example, given that the terminal 20, 21 is connected to a network 2 separate from the network 1 to which the requesting terminal 10 is attached, the control entity 100 determines a router of its own communications network 1 able to filter the stream(s) coming from the terminal 20 presumed to be malicious, using information relating to the topology of the network 1, the address of the terminal 20 or 21 presumed to be malicious, and the address in the communications network 1 of the requesting terminal 10. This router can be a router 30 that routes all streams sent to the requesting terminal 10 or a router for routing streams coming from the communications network 2.

In a step E22, the entity 100 sends the determined router a command to filter the stream(s) and stores the parameters thereof in the record associated with the session identifier Id_session1. This can be an access control list (ACL) internal filtering command (IFC) containing the addresses in the underlying network 2 of the terminal 20, 21 presumed to be malicious, as the source, and the requesting terminal 10, as the destination. An access control list is a collection of instructions for authorizing or rejecting packets as a function of criteria such as source address, destination address, port number, higher layer protocols.

The access control lists enable an administrator to manage traffic and analyze particular packets in a router.

The access control lists are associated with an interface of the router and all traffic routed via that interface is checked in order to detect therein certain conditions forming part of the access control list. Thus an access control list controls the traffic stream(s) routed via this interface.

It is not necessary for the router to effect an in-depth analysis of the data transmitted in the streams in order to filter the streams. Furthermore, it is not sensitive to the activation of a data protection function such as encryption. The requesting terminal 10 is no longer inconvenienced by undesirable streams coming from the terminal 20, 21 presumed to be malicious.

In a step E23 the control entity 100 checks if the terminal 20, 21 presumed to be malicious is registered with another control entity 200.

If so, as with the terminal 20 in the present example, in a step E24 the control entity 100 sends to the other control entity 200 a “presumed malicious” notification message in respect of the terminal 20 presumed to be malicious. The “presumed malicious” notification message comprises the session identifier Id_session2 associated with the terminal 20 presumed to be malicious, for example.

Otherwise, as with the terminal 21 in the present example, in a step E25 the control entity 100 sends to another control entity 200 a “presumed malicious” notification message in respect of the terminal 21 presumed to be malicious, determined as a function of the communications network 2 to which the terminal 21 presumed to be malicious is attached. The “presumed malicious” notification message comprises the address in the communications network 2 and the TCP port number associated with the terminal presumed to be malicious, for example.

The processing effected by a control entity 100 on reception of such messages is explained later. The process loops to the step E1 of waiting to receive a message.

When the user of the terminal 10 wishes to disconnect from the P2P network and no longer to be registered with the malicious stream control service, it sends the undesirable stream control entity 100 a registration cancellation message containing its session identifier Id_session1.

In a step E50, the control entity 100 checks that the message received is a registration cancellation message. In a step E51, it reads the record associated with the session identifier Id_session1 to obtain all the internal filtering command parameters sent to routers of the communications network 1 and placed in memory. Then, in a step E52, it sends each of those routers a filtering cancellation command as a function of the internal filtering command parameters previously sent to that router, thereby canceling the internal filtering command that is active for that router. The process then loops to the step E1 of waiting to receive a message.

Thus the communications network 1 does not remain in charge of filtering commands that are no longer of interest to the requesting terminal 10.

The method as used by a control entity 200 receiving a “presumed malicious” notification message from another control entity 100 is described next.

In a step E40, the control entity 200 receives a “presumed malicious” notification from another control entity. If the terminal presumed to be malicious is registered with the control entity 200, as with the terminal 20 in the present example, this notification contains the session identifier Id_session2 associated with the terminal 20 presumed to be malicious. If the terminal is not registered with the control entity 200, as with the terminal 21 in the present example, this notification contains the address in the communications network 2 and the TCP port number associated with the terminal 21 presumed to be malicious.

In a step E41, if the terminal 20 is registered, this notification is stored in the record associated with the session Id_session2 of the terminal 20 presumed to be malicious. If not, as with the terminal 21, for example, this notification is stored in a record associated with the address in the communications network 2 received in the notification.

In a step E42, if the terminal 20 presumed to be malicious is registered, it is notified of the reception of a “presumed malicious” notification concerning it. If it is not malicious, the terminal 20 can then instigate actions to find the cause of this notification. For example, it may have been the victim of address theft in the underlying communications network. Thus the user of the terminal 20 can take action regarding the perception of its reputation by the other peers.

In a step E43, the control entity 200 determines the number of “presumed malicious” notifications it has received for the terminal 20, 21 presumed to be malicious and checks if that number is greater than a predetermined number, for example a number of the order of ten. This number can be a parameter set by the administrator of the stream control entity. If this is not so, the method loops to the step E1 of waiting to receive a message. Otherwise, if this is so, in a step E44, the control entity 200 determines a router of the underlying communications network 2 able to filter the streams sent by the terminal 20, 21 presumed to be malicious, using information relating to the topology of the communications network 2 and the address in the communications network 2 of the terminal 20, 21 presumed to be malicious. In a step E45, it sends an internal filtering command in respect of all the streams sent by the terminal 20 presumed to malicious. Note that in these circumstances the filtering is effected in the communications network 2 to which the terminal 20, 21 presumed to be malicious is connected. This avoids routing undesirable streams by filtering them as close as possible to the source and without loading other communications networks, such as the network 1. The process then loops to the step E1 of waiting to receive a message.

The method has been described in the context of a P2P network connecting terminals 10, 20 and 21 respectively attached to different communications networks 1, 2. The process is easy to transpose to the context of a P2P network connecting terminals 10 and 11 attached to the same communications network 1. Under such circumstances, the notification of presumption of maliciousness is a notification internal to the undesirable stream control entity 100. The method is therefore applied in its entirety.

An undesirable stream control entity 100 is described next with reference to FIG. 3a.

An entity 100 for controlling undesirable streams coming from a terminal 20 presumed to be malicious belonging to an overlay network superposed on an underlying communications network comprises:

means 110 for storing information relating to the topology of the communications network 1;

a module 101 adapted to receive a filtering request in respect of a stream coming from a terminal presumed to be malicious and sent by a requesting terminal belonging to the overlay network;

a module 102 for determining a node of the communications network 1, adapted to determine a node able to filter the stream(s) as a function of a filtering request received by the receiver module 101;

a module 103 for sending the determined node a command to filter a stream or a command to stop filtering.

The control entity 100 can also comprise a module 104 for registering requesting terminals, adapted to check the right to access the filtering service and to assign a session identifier to a registered terminal.

It further comprises storage means 111 adapted to store information relating to filtering requests sent by a registered terminal.

It optionally further comprises a “presumed malicious” notification module 105 adapted to notify another control entity that a terminal registered with the other control entity is presumed to be malicious.

A requesting terminal 10 is described next with reference to FIG. 3b.

A requesting terminal belonging to an overlay network superposed on an underlying communications network comprises:

an overlay network connection module 130;

a module 131 for determining a terminal presumed to be malicious belonging to the overlay network;

a module 132 for sending an undesirable stream control entity a filtering request, adapted to send a request to filter a stream coming from a terminal presumed to be malicious as determined by the determination module 131.

The requesting terminal can further comprise a confidence level management module 133 adapted to evaluate a confidence level of a terminal, to store confidence levels in a confidence level database, and to share its own confidence levels with other terminals of the P2P network.

The invention also concerns a system for controlling undesirable streams coming from a terminal presumed to be malicious belonging to an overlay network superposed on an underlying communications network, comprising:

a control entity 100 as described above;

a requesting terminal 10 as described above.

The modules 101, 102, 103, 104, and 105 that implement the method described above are preferably software modules comprising software instructions for executing the steps of the method described above, executed by the control entity. The invention therefore also concerns:

a program for an entity for controlling undesirable streams coming from a terminal presumed to be malicious, comprising program code instructions adapted to command execution of the steps of the method when said program is executed by said entity; and

a storage medium readable by a device and on which the program for a stream control entity is stored.

The modules 131, 132, 133 that implement the method described above are preferably software modules comprising software instructions executed by the requesting terminal to determine a terminal presumed to be malicious belonging to the overlay network, to send a filtering request to an undesirable stream control entity, and to manage confidence levels, as described above.

The software modules can be stored in or transmitted by a data medium which can be a hardware storage medium, for example a CD-ROM, a magnetic diskette or a hard disk, or a transmission medium such as an electrical, optical or radio signal, or a telecommunications network.

1. A method of filtering undesirable streams coming from a terminal presumed to be malicious belonging to an overlay network superposed on an underlying communications network, comprising the following steps executed by an undesirable stream control entity:
a step of receiving a request to filter a stream coming from a terminal presumed to be malicious sent by a requesting terminal belonging to the overlay network;
a step of determining a node of said communications network able to filter said stream; and
a step of sending the determined node a command to filter said stream.

2. The method according to claim 1, further comprising, prior to the step of receiving a filtering request sent by a requesting terminal, a step of registering the requesting terminal with the control entity and, if the requesting terminal is no longer registered with said entity, a step of sending the determined node a command to cancel filtering of said stream.

3. The method according to claim 2, further comprising, if the terminal presumed to be malicious is registered with another undesirable stream control entity, a step of notifying the presumption of maliciousness of the terminal presumed to be malicious by the control entity to said other control entity.

4. The method according to claim 3, comprising, if said other control entity receives a plurality of “presumed malicious” notifications in relation to a terminal presumed to be malicious, a step of determining a node able to filter the streams sent by the terminal presumed to be malicious and a step of sending said determined node a command to filter all streams sent by the terminal presumed to be malicious.

5. An entity for controlling undesirable streams coming from a terminal presumed to be malicious belonging to an overlay network superposed on an underlying communications network, comprising:
means for receiving a request to filter a stream coming from a terminal presumed to be malicious sent by a requesting terminal belonging to the overlay network;
means for determining a node of said communications network able to filter said stream; and
means for sending the determined node a command to filter said stream.

6. A terminal belonging to an overlay network superposed on an underlying communications network, comprising:
means for determining a terminal presumed to be malicious belonging to the overlay network;
means for sending a filtering request to a control entity, adapted to send a request to filter a stream coming from the determined terminal presumed to be malicious.

7. A system for control undesirable streams coming from a terminal presumed to be malicious belonging to an overlay network superposed on an underlying communications network, comprising:
an entity for controlling undesirable streams coming from a terminal presumed to be malicious belonging to an overlay network superposed on an underlying communications network, comprising:
means for receiving a request to filter a stream coming from a terminal presumed to be malicious sent by a requesting terminal belonging to the overlay network;
means for determining a node of said communications network able to filter said stream; and
means for sending the determined node a command to filter said stream; and
a terminal belonging to an overlay network superposed on an underlying communications network, comprising:
means for determining a terminal presumed to be malicious belonging to the overlay network; and
means for sending a filtering request to a control entity, adapted to send a request to filter a stream coming from the determined terminal presumed to be malicious.

8. A program for an entity for controlling undesirable streams coming from a terminal presumed to be malicious, comprising program code instructions adapted to command execution of the steps of the method according to claim 1 when said program is executed by said entity.

9. A storage medium readable by a device in which the program according to claim 8 is stored.
